(19) United States
(12) Patent Application Publication
(10) Pub. No.: US 2012/0291086 A1
(43) Pub. Date: Nov. 15, 2012

(54) BROADCAST RECEIVING APPARATUS AND COMPUTER PROGRAM PRODUCT

(75) Inventor: Hiroyuki Oka, Tokyo (JP)

(73) Assignee: KABUSHIKI KAISHA TOSHIBA, Tokyo (JP)

(21) Appl. No.: 13/559,457

(22) Filed: Jul. 26, 2012

Related U.S. Application Data
(63) Continuation of application No. 12/546,548, filed on Aug. 24, 2009.

(30) Foreign Application Priority Data
Sep. 26, 2008 (JP) 2008-248800

(51) Int. Cl. H04N 21/47

(52) U.S. Cl. 725/134

(57) ABSTRACT

A broadcast receiving apparatus includes an operation receiving module for receiving a user operation; a broadcast receiving module for receiving broadcast contents including view restriction level information; a view restricting module for restricting viewing of the broadcast contents if the view restriction level information meets preset conditions; a decoding module for decoding the broadcast contents not being subject to the view restriction; and a display control module. The display control module displays videos of the decoded broadcast contents on a display device and to display, in a first form, a predetermined object displayed on the display device if the broadcast contents are not subject to the view restriction. The display control module also displays the object in a second form if the broadcast contents are subject to the view restriction. The view restricting module releases the view restriction if the operation receiving unit receives a user operation on the object.

### CROSS-REFERENCE TO RELATED APPLICATIONS

This application is a continuation of U.S. patent application Ser. No. 12/546,548, filed Aug. 24, 2009, which is based upon and claims the benefit of priority from Japanese Patent Application No. 2008-248800, filed Sep. 26, 2008, the entire contents of these applications are incorporated herein by reference.

### BACKGROUND

1. Field

One embodiment of the invention relates to a broadcast receiving apparatus and a computer program product thereof.

2. Description of the Related Art

In recent years some broadcasting programs, targeted for adult audience, have been broadcasted as exclusive channels for adult audience. Watching such programs are restricted unless the audience enters the password.

In television broadcasting, some programs occasionally include extremely violent or obscene contents, therefore it has been hoped to restrict viewing of these programs as they are undesirable from educational viewpoints of children.

A trend to restrict viewing of these programs has been especially conspicuous in America, and the Telecommunications Act of 1996 is enacted. According to the Act, the broadcasting stations have been obliged to superimpose rating information, which indicates extremeness of the programs, on the broadcasting signals. Moreover the television sets that receive the aforementioned programs are obliged to include functions to restrict watching of these programs so as to be able to implement the restriction using the rating information.

Functions that restrict violent or obscene scenes are called a parental lock, which is for example disclosed in Japanese Examined Patent Application Publication (KOKOKU) No. H04-148841. According to this disclosure, when the parental lock is being implemented, an indicator that indicates parental lock state flickers, and neither images nor sounds come out of the television set. As a result, it is impossible to watch the broadcast that is parental locked unless the parental lock is released.

According to the technology disclosed in KOKOKU No. H04-148841, it is possible to release the parental lock by entering the password after operating a satellite designated switch.

However, according to the technology disclosed in KOKOKU No. H04-148841, it is difficult to know which switch should be operated to release the parental lock.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram illustrating hardware structure of a broadcast receiving apparatus according to an embodiment of the present invention;

FIG. 2 is a block diagram illustrating a functional structure of the broadcast receiving apparatus;

FIG. 3 is an exemplary front view of a displayed image;

FIG. 4 is a flowchart illustrating a broadcast receiving process;

FIG. 5 is a front view of the displayed image when the parental lock is functioning; and

FIG. 6 is a front view of the displayed image including the password entry screen.

### DETAILED DESCRIPTION

Various embodiments of according to the invention will be described hereinafter with reference to the accompanying drawings. In general, according to one embodiment of the invention, a broadcast receiving apparatus includes an input module; an operation receiving module configured to receive a user operation through the input module; a broadcast receiving module configured to receive broadcast contents including view restriction level information for indicating view restriction; a view restricting module configured to restrict viewing of the broadcast contents if the view restriction level information in the broadcast contents meets preset conditions; a decoding module configured to decode the broadcast contents not being subject to the view restriction by the view restricting module; and a display control module configured to display video of the decoded broadcast contents on a display device and to display, in a first form, a predetermined object displayed on the display device if the broadcast contents are not subject to the view restriction by the view restricting module, the display control module being configured to display the predetermined object in a second form different from the first form if the broadcast contents are subject to the view restriction by the view restricting module, wherein the view restricting module releases the view restriction if the operation receiving unit receives a user operation on the predetermined object.

According to another embodiment of the invention, a computer program product has a computer readable medium including programmed instructions, wherein the instructions, when executed by a computer, cause the computer to perform: receiving a user operation through an input module; receiving broadcast contents including view restriction level information for indicating view restriction; restricting viewing of the broadcast contents if the view restriction level information in the broadcast contents meets preset conditions; decoding the broadcast contents not being subject to the view restriction; displaying videos of the decoded broadcast contents on a display device and displaying, in a first form, a predetermined object displayed on the display device if the broadcast contents are not subject to the view restriction; and displaying the predetermined object in a second form different from the first form if the broadcast contents are subject to the view restriction, wherein the view restriction is released if a user operation on the predetermined object is received.

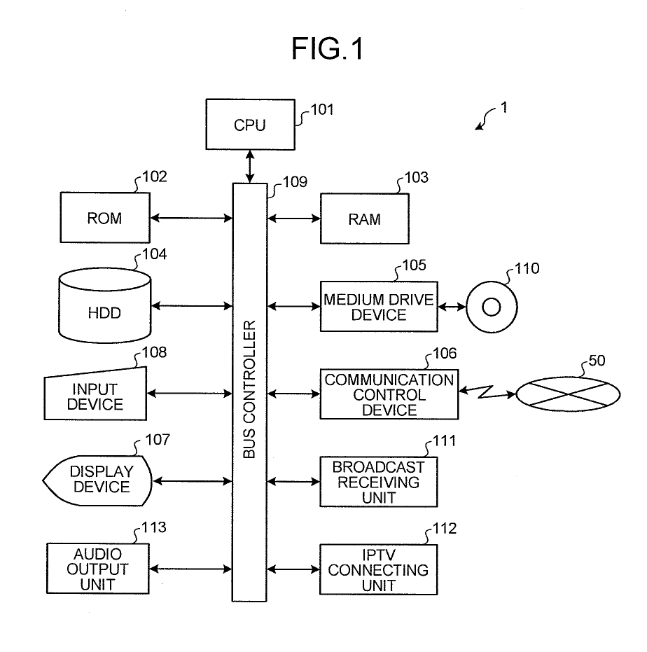

An embodiment of the invention will be explained referring to accompanying drawings FIG. 1 to FIG. 6. The present embodiment describes an example in which a notebook portable computer is used as a broadcast receiving apparatus.

FIG. 1 is an exemplary block diagram illustrating hardware structure of the broadcast receiving apparatus according to an embodiment of the present invention. As illustrated in FIG. 1, a broadcast receiving apparatus 1 includes: a Central Processing Unit (CPU) 101 that executes information processing; a Read Only Memory (ROM) 102 that stores BIOS for example; a Random Access Memory (RAM) 103 that rewritably stores various types of data; a Hard Disk Drive (HDD) 104 that functions as various types of databases and stores various types of programs; a medium drive device 105, such as a DVD drive, for storing, distributing information, or acquiring information from outsides through a recording medium 110; a communication control device for exchanging information with an external computer via a network 50; a display apparatus 107, such as a Liquid Crystal Display (LCD), for showing progress and results of processing to the user; an input device 108, such as a keyboard and a pointing device, for enabling the user to enter instructions and information into the CPU 101; a broadcast receiving unit 111 that is a broadcast receiver for receiving the video contents (TV program) broadcasted from selected broadcasting station via an antenna or a cable (not shown); an IPTV (Internet Protocol Television) connecting unit 112 that is a broadcast receiver and is also an interface connected with an IPTV server 200; and an audio output unit 113. A bus controller 109 acts to arbitrate data exchanged between the aforementioned units.

The IPTV server 200 is a server for providing services that deliver videos such as TV programs and movies using the IP. Specifically, the IPTV server 200 delivers the contents such as videos in accordance with demands from the broadcast receiving apparatus 1.

In the broadcast receiving apparatus 1, when the user turns on the power, the CPU 101 launches a program named a loader in the ROM 102, and loads OS (Operating System), which is a program for controlling the hardware and software of the computer, in the RAM 103 from the HDD 104, and then starts up the OS. The OS launches the program, loads or stores information in accordance with the operation of the users. A typical OS is Windows (Registered Trademark). Those operation programs that run on the OS are called application programs. The application programs are not limited to those programs that are operable on a specific OS, but the application programs may be programs that make the OS execute a part of various processes which will be explained later, or may be included as a part of program file group that constitutes a specific application software or OS.

The broadcast receiving apparatus 1 stores an image processing program as an application program in the HDD 104. In this regard, the HDD 104 functions as a recording medium that stores the image processing programs.

In general, the application programs that are installed in the HDD 104 of the broadcast receiving apparatus 1 are stored in the recording medium 110 including: various types of optical disks such as DVD; various types of optical magnetic disks; various types of magnetic disks such as flexible disks; and semiconductor memory. Then the operation programs stored on the recording medium 110 are installed in the HDD 104. Accordingly, the recording medium 110 may be a portable recording medium for storing the application programs, including an optical information medium such as DVD and the magnetic medium such as FD. Furthermore, for example, the application programs may be acquired from the external network 50 via the communication control device 106 and installed in the HDD 104.

According to the broadcast receiving apparatus 1, when a broadcast receiving program that is operable on the OS is launched, the CPU 101 controls each of the units intensively by executing various arithmetic processes. Typical arithmetic processes according to the present embodiment, among various arithmetic processes that the CPU 101 executes, will be explained bellow.

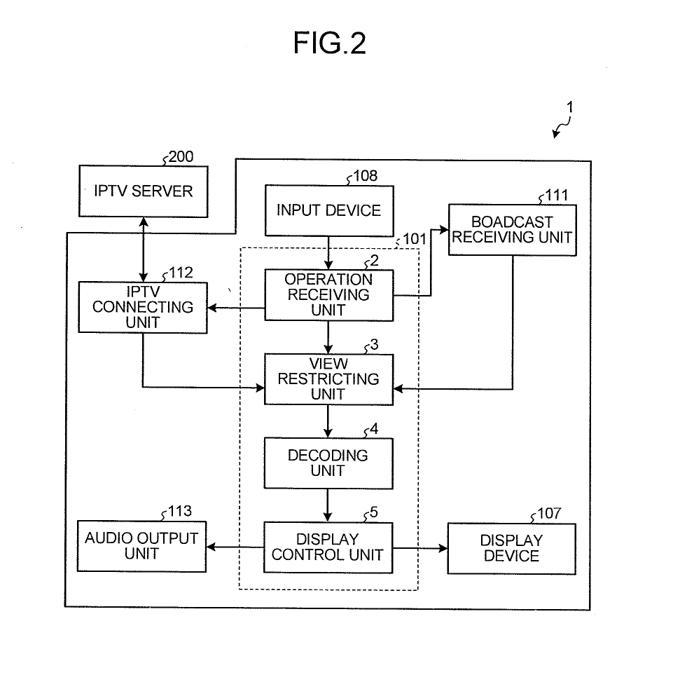

FIG. 2 is a block diagram illustrating functional structure of the broadcast receiving apparatus 1. As illustrated in FIG. 2, the broadcast receiving apparatus 1, by following the broadcast receiving program, realizes each of functional units to function, including an operation receiving unit 2, a view restricting unit 3, a decoding unit 4, and a display control unit 5.

The decoding unit 4 acquires video contents that the user wants to reproduce, including contents of TV programs that are received by the broadcast receiving unit 111 and video contents that are acquired from the IPTV server 200 via the IPTV connecting unit 112. The decoding unit 4 then decodes (reproduces) the acquired contents and transmits the decoded contents to the display control unit 5.

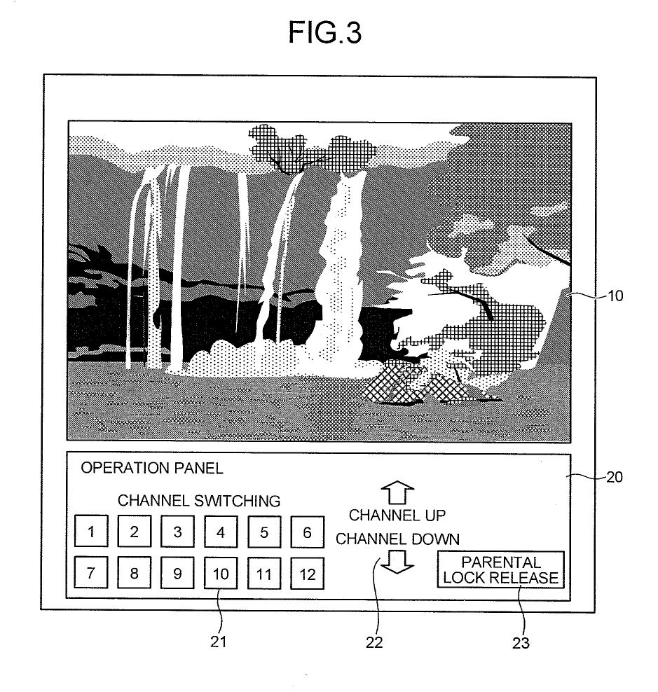

As illustrated in FIG. 3, the display control unit 5 displays, on the display apparatus 107, a contents display area 10 where contents transmitted by the decoding unit 4 are reproduced and displayed, and an operation panel 20 that receives various operations such as channel switching via the input device 108. The display control unit 5 also outputs sounds of the contents transmitted by the decoding unit 4 from the audio output unit 113. The operation panel 20 includes channel selection buttons 21 for selecting channels, and channel UP/DOWN switching buttons 22 for switching channels in an ascending order or in a descending order. To implement demands from the channel UP/DOWN switching buttons 22, it is necessary to previously identify and store the next and previous channels.

When parental level information (view restriction information) which restricts viewing of violent or obscene scenes is superimposed on signals transmitted from the IPTV server 200 or a broadcasting station, the view restricting unit 3 executes a parental lock function which restricts viewing of the violent or obscene scenes. Specifically, when the parental level information which restricts viewing of the violent or obscene scenes is superimposed on signals, and when the parental level information meets preset conditions which prohibit outputting the signals, the view restricting unit 3 makes a state in which neither videos are displayed on the contents display area 10 nor sounds are output from the audio output unit 113, by stopping transmitting the contents to the decoding unit 4.

The operation panel 20 includes a parental lock function release button 23 which indicates that the parental lock function is executed by the view restricting unit 3 and releases the parental lock function. The parental lock function release button 23 is able to flicker.

The operation receiving unit 2 receives operation by detecting which button on the operation panel 20 is clicked by the user via the input device 108 such as a pointing device. For example, channel selection is conducted when an instruction of channel selection is transmitted to the broadcast receiving unit 111 or the IPTV connecting unit 112 from the operation receiving unit 2 when the channel selection buttons 21 or channel UP/DOWN switching buttons 22 are operated by the user. The channel selection here means to select the broadcasting station and to receive the broadcast from a given broadcasting station. When the parental lock function release button 23 is operated by the user, an instruction of the parental lock function release is transmitted to the view restricting unit 3 from the operation receiving unit 2. In response to this, the parental lock release operation is executed.

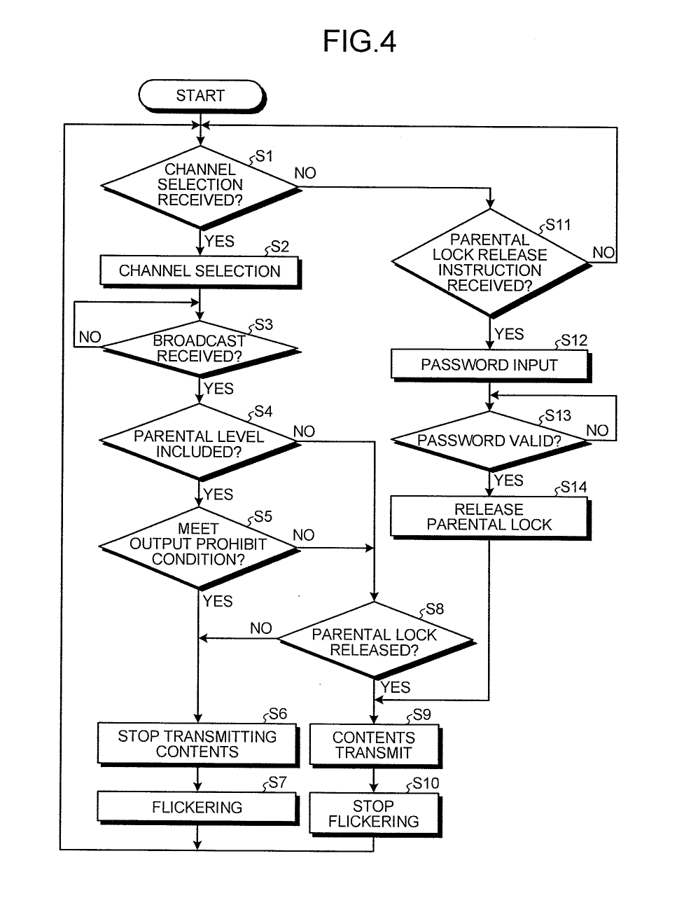

A flow of the broadcast receiving process by the broadcast receiving apparatus 1 is explained below. FIG. 4 is a flowchart illustrating the flow of the broadcast receiving process by the broadcast receiving apparatus 1.

When the operation receiving unit 2 determines that the channel selection is instructed by detecting which channel selection button 21 or channel UP/DOWN switching button 22 is clicked via the input device 108 such as the pointing device (step S1, Yes), the operation receiving unit 2 executes the channel selection by transmitting the instruction of the channel selection to the broadcast receiving unit 111 or the IPTV connecting unit 112 (step S2).

When the broadcast receiving unit 111 or the IPTV connecting unit 112 receives the broadcast from the given broadcasting station (step S3, Yes), the view restricting unit 3 determines whether the parental level information which restricts viewing of the violent or obscene scenes is superimposed on the signals transmitted from the IPTV server 200 or broadcasting station (step S4).

If the view restricting unit 3 determines that the parental level information is superimposed (step S4, Yes), then the view restricting unit 3 determines whether the parental level information meets preset output prohibiting conditions (step S5).

If the parental level information meets the preset output prohibiting conditions (for example, prohibiting those who are 15 years old or less from watching) (step S5, Yes), the view restricting unit 3 prohibits displaying images on the contents display area 10, makes a state in which no sounds are output from the audio output unit 113, and makes the parental lock function release button 23 flicker (step S7) by stopping transmitting the contents to the decoding unit 4 (step S6).

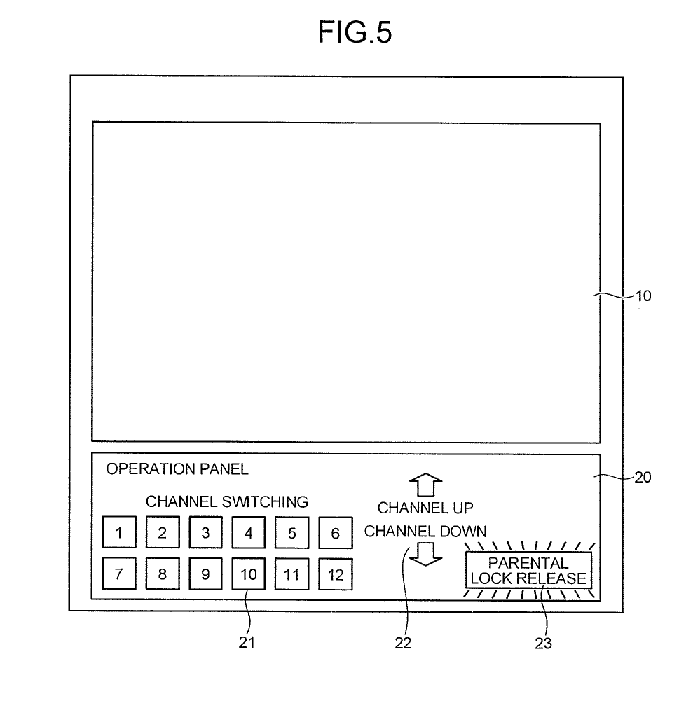

FIG. 5 is a front view of the displayed image when the parental lock is functioning. As illustrated in FIG. 5, if the parental level information meets the output prohibiting conditions which are preset in the broadcast receiving apparatus 1, the view restricting unit 3 makes a state in which no videos are displayed on the contents display area 10 which is displayed in the display device 107, and no sounds are output from the audio output unit 113. In addition, if the parental level information meets the output prohibiting conditions which are preset in the broadcast receiving apparatus 1, the view restricting unit 3 makes the parental lock function release button 23 flicker so that the user instinctively perceives that the parental lock function is on.

Alternatively, if the view restricting unit 3 determines no parental level information is superimposed (step S4, No), or the view restricting unit 3 determines the parental level information does not meet the output prohibiting conditions which are preset in the broadcast receiving apparatus 1 (step S5, No), on condition that the parental lock is released (step 8, Yes), the contents are transmitted to the decoding unit 4 (step S9). As a result of this, as illustrated in FIG. 3, the view restricting unit 3 makes a state in which the videos are displayed on the contents display area 10 which is displayed in the display device 107, the sounds are output from the audio output unit 113, and the parental lock function release button 23 stops flickering (step S10).

On the other hand, if the view restricting unit 3 determines no parental level information is superimposed (step S4, No), or the view restricting unit 3 determines the parental level information does not meet the output prohibiting conditions which are preset in the broadcast receiving apparatus 1 (step S5, No), and if the parental lock is not released (step 8, No), the flow proceeds to step S6.

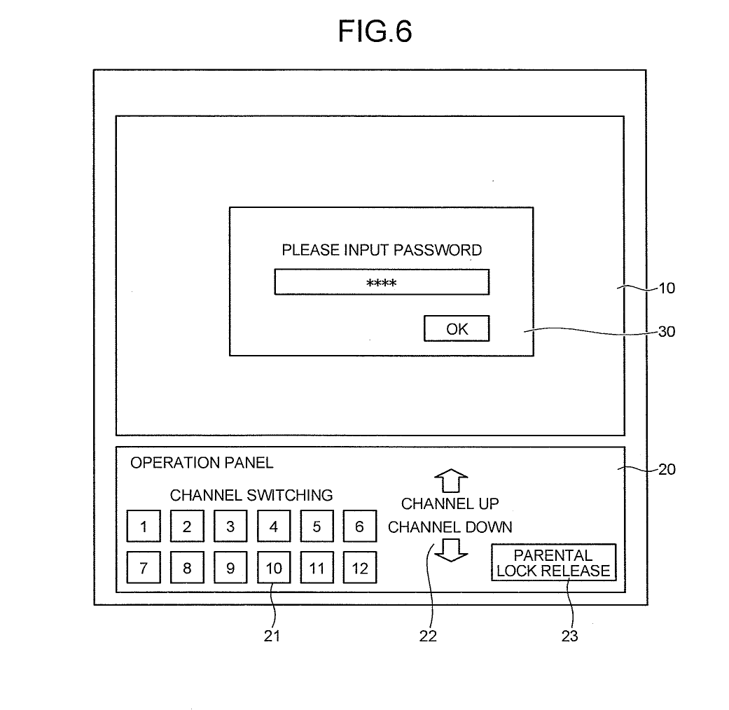

Releasing the parental lock function will be explained next. If the operation receiving unit 2 determines, by detecting the parental lock function release button 23, which is provided to the operation panel 20, is clicked via the input device 108 such as the pointing device, that the parental lock function release instruction is made (step S11, Yes). As illustrated in FIG. 6, a password entry screen 30 (password entry window) is displayed on the display device 107, and the password entry screen 30 waits for a password to be entered by the user via the input device 108 (step S12). The parental lock release can be operated and the password entry screen 30 is displayed regardless of whether the parental lock function release button 23 is flickering or not.

If the password entry by the user is proved to be valid (step 13, Yes), the view restricting unit 3 releases the parental lock (step S14) and transmits the contents to the decoding unit 4 (step S9). Then, as illustrated in FIG. 3, the videos are displayed on the contents display area 10 which is displayed in the display device 107 and sounds are output from the audio output unit 113.

In a state when the parental lock function is not executed, and the parental lock function release button 23 provided to the operation panel 20 is clicked via the input device 108 such as the pointing device, if the parental lock function is released after a password is entered, even if the violent or obscene scenes are superimposed in the signals transmitted from the IPTV server 200 or broadcasting station, the contents are inevitably reproduced. In other words, it is possible to make the parental lock function invalid before receiving the broadcast from the given broadcasting station using the broadcast receiving unit 111 or the IPTV connecting unit 112 by displaying the parental lock function release button 23 on the operation panel 20 all the time (when the parental lock function is not implemented). When making the parental lock function invalid before receiving the broadcast, it is possible to prevent children from mistakenly viewing the violent or obscene scenes, by making the parental lock function invalid only in a certain period of time (for example, until the power is turned on next time) instead of making the parental lock function invalid forever.

According to the present embodiment, if viewing of the broadcast contents is not restricted by the view restricting unit 3, the decoded contents are displayed on the display device 107. If viewing of the broadcast contents is restricted by the view restricting unit 3 due to the parental level information in the broadcast contents meets the preset conditions, in order to indicate viewing the broadcast contents is restricted, the parental lock function release button 23 is displayed in a second form (for example by flickering) which is different from a first form as a normal state. When the operation receiving unit 2 receives the operation, by the user via the input device 108, to the parental lock function release button 23, which is a predetermined object indicated by the second form (for example by flickering) which is different from the first form as the normal state, the view restricting unit 3 releases the parental lock to the broadcast contents. It is possible to release the parental lock to the broadcast contents by operating the parental lock function release button 23, which is displayed in a different manner from the normal manner on the display device 107. Therefore, when releasing the parental lock to the broadcast contents becomes necessary, it is possible to release the parental lock to the broadcast contents by operating the parental lock function release button 23 which is displayed on the display device 107. As a result, the user is able to instinctively and without confusion understand how to release the parental lock to the broadcast contents, and the user friendliness is improved in releasing the parental lock to the broadcast contents.

In the case of zapping in which the user switches the channels by pressing the channel UP/DOWN buttons 22, the display device 107 becomes only the state same as the parental lock (namely, no images are displayed on the contents display area 10 which is displayed in the display device 107, and no sounds are output from the audio output unit 113), therefore it is possible to switch the channels to continuously because no other screens such as confirmation screens are displayed.

According to the present embodiment, when the parental lock is being executed, the parental lock function release button 23 is made to flicker as a predetermined object, however the predetermined object is not limited to the parental lock function release button 23. For example, when no images are displayed on the contents display area 10, a frame of the contents display area 10 may be made to flicker. In this case, in order to release the parental lock function it may be made to click the flickering frame of the contents display area 10 via the input device 108 such as a pointing device.

Informing the user that the parental lock function is being executed is not limited to making the parental lock function release button 23 flicker (changing the appearance different from normal). Changing the appearance different from normal may include mere lighting or changing of colors.

The various units and processes described herein can be implemented as software applications, computer readable media including programmed instructions of the software applications, computer program products having the computer readable media, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast receiving apparatus comprising:
a command receiver configured to receive a command through an input module;
a broadcast receiver configured to receive broadcast contents comprising view restriction level information specifying view restriction;
a view controller configured to restrict playing the broadcast contents when the view restriction level information in the broadcast contents meets predetermined conditions and the view restriction is not canceled;
a video player configured to play video of the broadcast contents not restricted by the view controller;
a first display controller configured to display the played video of the decoded broadcast contents together with a button in a first form on a display device when the broadcast contents are not restricted by the view controller, and to display the button in a second form of being flickering when the broadcast contents are restricted by the view controller; and
a second display controller configured to display an image to cancel the view restriction on the broadcast contents when the command receiver receives a command through the button displayed in the first form or the second form.

2. The broadcast receiving apparatus of claim 1, wherein the command receiver is configured to receive a command provided with a pointing device through the button.

3. The broadcast receiving apparatus of claim 1, wherein the second display controller is configured to display an image to input a password when a command is provided through the button.

4. The broadcast receiving apparatus of claim 1, wherein the first display controller is configured to display the button in the first form or the second form indicating that the view restriction on the broadcast contents can be canceled.

5. The broadcast receiving apparatus of claim 1, wherein the first display controller is configured to display the button equal in size to a range in which the broadcast contents are displayed.

6. A computer program product in a computer readable medium comprising programmed instructions, wherein the instructions, when executed by a computer, cause the computer to implement:
a command receiver configured to receive a command through an input module;
a view controller configured to restrict playing broadcast contents when view restriction level information specifying view restriction in the broadcast contents meets predetermined conditions and the view restriction is not canceled;
a video player configured to play video of the broadcast contents not restricted by the view controller;
a first display controller configured to display the played video of the broadcast contents and a button in a first form on a display device when the broadcast contents are not subject to the view restriction by the view controller, and to display the button in a second form of being flickering when the broadcast contents are subject to the view restriction by the view controller; and
a second display controller configured to display an image to cancel the view restriction on the broadcast contents when the command receiver receives a command through the button displayed in the first form or the second form.
